(19) United States
(12) Patent Application Publication
(10) Pub. No.: US 2003/0089251 A1
(43) Pub. Date: May 15, 2003

(54) Microparticle screen printing ink

(76) Inventors: Bill Brown, Blue Springs, MO (US); Heather Knechtges, Saline, MI (US)

Correspondence Address: FISH & RICHARDSON P.C., 3300 DAIN RASCHER PLAZA, 60 SOUTH SIXTH STREET, MINNEAPOLIS, MN, 55402, US

(21) Appl. No.: 09/994,232

(22) Filed: Nov. 14, 2001

(51) Int. Cl. B41M 1/12

(52) U.S. Cl. 101/129

(57) ABSTRACT

Compositions, methods, and apparatus for use in connection with printing inks, including screen printing inks. The printing ink contains microparticles made of a resinous or plastic material such as polyurethane or polystyrene. In one embodiment, a water-based screen printing ink composition includes 20% by weight transparent polyurethane microspheres having a mean particle size of about 18-25 microns and 5% by weight butyl cellosolve and 10% by weight water is printed using a 160 thread count mesh upon a 59# paper stock. That particular implementation produces a printed article in which the beads stack upon one another to effect a relatively continuous but random pattern of aberrations in the printed ink surface that provide a soft, leathery tactile property and substantially increased mar resistance. The mar resistance obviates the need to separately apply a protective varnish and substantially reduces production and materials costs.

### TECHNICAL FIELD

The invention relates to printing inks, and more particularly to screen printing ink compositions that include particulate additives.

### BACKGROUND

Liquid inks are used in a variety of distinct printing processes, including gravure, engraving, ink jet, and screen printing processes. The inks used in each of these techniques differ in several fundamental respects. Gravure ink is typically a low viscosity ink with viscoelastic properties adapted for high speed processes. Engraving ink typically has viscosity an order of magnitude higher than gravure ink and has different concentration of binders and colorants, commonly referred to as solids. Ink jet inks typically have a viscosity an order of magnitude lower than gravure inks, which adapts the ink to be deposited in small drops the paths of which are controlled by an electric field. Silk screen inks, conversely, are typically two orders of magnitude more viscous than ink jet inks and must have distinct viscoelastic properties.

Screen techniques are typically employed where increased color density or special effects are desired. The silk screen process deposits a thicker layer of ink upon the target paper or textile than do gravure, engraving, or ink jet techniques. More colorant, or pigment, is deposited per unit area, which in turn causes the hues to be deeper and richer. The increased thickness of the deposited ink likewise creates unique mattes, textures and tactile properties.

Especially when such effects are desired, it is often necessary to coat the ink with a protective varnish or other material to prevent the screen ink from being damaged. Abrasion or pressure upon an unprotected screen ink can easily mar the image by visibly altering the texture of the abrased or pressed portion of the images. Protective varnishes and the like are accordingly used to protect the screen ink. However, application of such protective varnishes often requires an additional process step and necessarily increases raw material and processing costs. The varnishes can also undesirably alter the texture or other properties of the underlying screen ink. That in turn necessitates adjustments in the formulation of the base screen ink to compensate for the effect of the protective varnish.

Modification of the base ink presents several challenges. Screen printing processes are controlled by an array of interdependent design parameters. The thixotropy, a property closely related to viscosity, must be carefully controlled so as to ensure that the appropriate amount of ink is deposited upon the printed article. The thixotropy of an ink is directly affected not only by its solvent, binder, and colorant, but also by the quantity, material, and character of any additives. The colorant and binder concentrations affect the intensity and printability of the screen ink, but modification of either will affect the thixotropy, the amount of ink deposited, and accordingly the intensity and character of the resulting printed image. Moreover, the screen itself must be selected so as to be compatible with the ink solvent and able to transmit to a preselected quantity of ink during a screen printing operation. Depending on the precise combination of ink, additive, and screen selected, the screen printing process itself must be redesigned to ensure that the desired ink deposition is achieved. Any alteration of any of the foregoing parameters can render then entire process ineffectual unless and until further research identifies which complimentary or opposing changes can be made in one or more of the other parameters to remedy the problem.

### SUMMARY

The invention is directed to a composition, method, and apparatus for use in connection with printing inks, including screen printing inks. The printing ink contains microparticles made of a polymeric material such as polyurethane, polystyrene, or polyolefin, or an inorganic material such as glass beads. In one embodiment, a water-based screen printing ink composition includes 20% by weight transparent polyurethane microspheres having a mean particle size of about 18-25 microns and 5% by weight butyl cellosolve and 10% by weight water is printed using a 160 thread count mesh upon a 59# paper stock.

Various embodiments of the invention can be implemented to realize one or more of the following advantages. Certain embodiments produce a printed article in which the beads stack upon one another to effect a relatively continuous but random pattern of aberrations in the printed ink surface that provides a tactile property that can range from a soft, leathery feel to a soft, velvety feel, to a rough, sandpaper feel based upon the mean particle size of the microspheres used. The beads also substantially increases the mar resistance of the ink, which in turn obviates the need to separately apply a protective varnish and thereby reduces production and materials costs. The microparticles added to some embodiments improve the texture and appearance of the ink. Other advantages, such as improved mechanical proprieties and increased compatibility with other additives and fillers, can be achieved by appropriate selection of microparticle and ink formulations in accordance with the teachings set forth below.

The details of this and several additional embodiments of the present invention are set forth in the description below. Other features and advantages of the present invention will be apparent from the description and drawings, and from the claims.

### DETAILED DESCRIPTION OF ILLUSTRATIVE EMBODIMENTS

In an illustrative embodiment, a screen printing ink comprised of solvents, a binder commonly referred to as a “resin,” a colorant, and polymeric microparticles is applied in a screen printing apparatus having a particular thread count, screen/sheet gap, blade angle and blade thickness. The selection and combination of each of the ink components is detailed below, followed by a delineation of the relevant parameters in the screen printing process. Finally, specific examples of water-based and solvent-based inks are provided.

The base screen printing ink of these illustrative embodiments is a water-based ink or a solvent-based ink. The ink can be selected to match the solubility of the microparticles. For example, urethane beads are most readily compatible with water-based inks, whereas solvent-based inks can be most readily implemented in connection with other particles made of materials such as styrene. The addition of beads will increase the viscosity and thixotropy of the ink, so the ink can be advantageously preselected to have a viscosity and thixotropy lower than that ultimately desired. Such an approach can obviate the need to dilute the ink with additional solvents, which in turn thins the ink, reduces the colorant density, and necessitates the addition of further resin and/or binder.

Use of inks cured with ultraviolet (UV) light and inks having high solid content (i.e., high binder and colorant concentrations) can be used but are not preferred because additional steps can be required to adjust viscosity, thixotropy, or other parameters to optimize the instant embodiment. As will be explained in further detail below, the mesh size is increased to accommodate the particulate additive, which tends to increase the thickness of the deposited ink, or the “ink bed.” The curing process is impeded by the additional thickness of the ink bed and the microparticles do not tend to protrude as fully from the ink bed, thereby reducing the net improvement in tactile properties, mar resistance, etc. The use of an increased intensity UV source can be used to compensate for the reduced cure rate. Alternately, the viscosity and thixotropy and/or the screen size can be adjusted so as to reduce the amount of ink deposited and ensure an acceptable cure rate. Inks with high solid content likewise tend to build up into a thicker ink bed, and particle size, weight percent, and/or screen size can be adjusted to compensate.

The microparticles are selected primarily based upon shape, size, solvent compatibility, and material properties. The microparticles can be substantially spherical, in which case they can be referred to as microspheres or microbeads, or can have a substantially aberrant contour. Spherical beads more easily stack upon one another during a screen printing operation, and that stacking increases the fraction and degree of bead protrusion from the ink bed on the printed article. The mar resistance and alteration in tactile properties are thereby substantially increased. Linear or aberrant counters increase gloss, change the patina of the ink, and permit the use of fillers than provide increased flexibility and dielectric properties.

The beads can be advantageously selected to be of a size that can freely pass through the selected screen mesh, discussed in further detail below, but large enough to protrude from the ink. As used herein, the term “protrude” contemplates that a substantial fraction of the protruding surface of the bead will be entirely covered with ink, but a layer whose thickness is relatively small relative to the ink bed. The maximum mean particle size permitted with a given mesh will be a function of the viscosity and thixotropy of the ink, which is in turn affected by the solid content of the ink. For a mesh count of 110, a mean particle size in the range of 18-55 is preferred and a mean particle size in the range of about 15-28 microns is most preferred. For other mesh counts, mean particle size in the range of about 28 to 40 microns are preferred and can be readily implemented in accordance with the teachings set forth herein.

Some urethane beads are compatible with water-based inks, whereas urethane beads are generally incompatible with solvent-based inks. It is understood that water-based inks contain some solvent, but a much lower concentration than solvent-based inks. Polystyrene microparticles are well suited for use in connection with solvent-based inks. The hardness of the selected microparticles directly affects the tactile properties of the resulting ink. Styrene-based microparticles provide less mar resistance but a harder, more solid feel. Softer, urethane beads provide increased mar resistance and a leather or velvet-like tactile property.

The weight percent, or quantity, of beads can be selected to optimize stacking. If too much stacking occurs, the resultant ink can have a chaulky, unattractive appearance. Conversely, if too little stacking is achieved, the printed product may appear unduly glossy. Generally speaking, an increased weight percent of beads promotes stacking for a given mean particle size and mesh thread count. However, increasing the bead weight percent has a diluent effect on the colorant density, so it is necessary to either use a larger mesh or add more resin and colorant to the ink. The former can cause undue ink bed build up, while the latter can cause undue gloss. The foregoing parameters can advantageously be balanced so as to optimize the ink's performance. In the illustrative embodiments referred to herein, a bead fraction of 5-30% by weight is preferred and 20% is most preferred.

The paper can advantageously be selected to be either coated or uncoated. Coated paper are less porous and accordingly will absorb less of the ink. Uncoated papers, by contrast, absorb and increased fraction of the ink, which causes a decrease in the thickness of the ink bed and tends to produce a more glossy appearance.

The screen itself can be advantageously selected to be compatible with the selected ink and provide the necessary mechanical properties. Polyester screens can be used in connection with either water- or solvent-based inks and provide a suitably stretch-resistant mesh. Some nylon meshes stretch substantially during the required screen printing procedures and are suitable for use only with solvent-based inks. The mesh size can be selected so as to accommodate a pre-selected ink's thixotropy, bead type, or both. Mesh thread counts (threads per inch) of 195 and lower are preferred, and meshes having a thread count of 90-160 are most preferred. Larger meshes (i.e. lower thread count meshes) provide increased color intensity but also increase ink bed thickness, thereby reducing bead protrusion and mitigating the improvement in tactile and mechanical properties.

Referring now to the screen printing apparatus itself, the blade angle, blade hardness, screen/sheet distance, and slow solvent concentration can be advantageously controlled to optimize the application of ink containing microparticles. The blade hardness is preferably in the range of about 30 to 90 Shore A, more preferably in the range of 50-60 Shore A, and most preferably about 55 Shore A. The blade angle is preferably in the range of 5 to 25 degrees, more preferably in the range of 10-20 degrees, and most preferably about 15 to 17 degrees. The distance between the sheet and the screen can be reduced to minimize screen stretching, which is exacerbated by the thixotropy of the ink. In the most preferred embodiment, the distance between is about ⅓ to ¼ inch. The use of slow solvent compensates for the increased drying rate due to the increased surface area caused by the presence of the beads in the ink. Preferably, a slow solvent such as butyl carbitol in a weight percent of about 2 to 10% is used to slow drying and promote the drawing of the ink away from the protruding bead surfaces. This drawing process minimizes the thickness of the ink layer on top of the beads and thereby increases the effectiveness of the beads in certain respects. When the beads are more thinly covered with ink, they tend to have an increased effect on the appearance, texture and related ink properties.

The invention is further illustrated by the following examples. Unless otherwise specified, the % units refer to % by weight. In formulations involving either water-based and solvent-base ink systems contain 20% beads. In both water and solvent systems the inks are thinned to provide a suitable “screen-printable” ink system.

### EXAMPLE 1

A water-based ink formulation consists of 10% water, 5% butyl cellosolve, 20% beads, and 65% ink. The base ink is Nazdar Aquasafe Flat POP Screen Ink. The thinning was achieved by the use of a water-base thinner available from Nazdar under the trade name Aquasafe P.O.P. Thinner, No. 2530. According to the manufacturer, the thinner consists of 85-90% water and 10-15% diethylene glycol butyl ether (2-(2-butoxytheyoxy)ethanol), also known as butyl cellosolve. Transparent polyurethane beads available from Microchem under the trade name Decosoft Transparent 30T are added to the ink and thinner. According to the manufacturer, the beads have the empirical formula R₁—NHCOO—R₂/R₃—NHCONH—R₄, a composition of 99% polyurethane and 1% humidity, and a median particle size of about 30 microns. Addition of the beads to the ink was accomplished by several minutes of high speed, low shear mixing in a standard ink mixer. Given the bead size, a screen at least as large as 195 should be used. Screens larger than 195 mesh such as 160 mesh, 156 mesh, or 110 mesh, yield a more consistent ink deposition and are therefore more desirable. Butyl carbitol, a slow solvent, is added to a concentration of 5%. A blade having a hardness of 55 Shore A was set at about 16 degrees during the printing operation. The paper was a 59# uncoated cardstock. The resulting printed article was found to be aesthetically and functionally superior to ink-and-varnish articles. The article had a soft, leathery, suede texture and substantially increased mar resistance.

### EXAMPLE 2

The solvent-based ink system of this example varies from the water based system of the foregoing example in that the amount of solvent used as thinner is much greater than for the water-based system. The formulation is 40% solvent base ink, 40% thinner, and 20% beads. The base ink is 7700 series Nazdar POP Plus Screen Ink. The thinning was achieved by the use of a water-base thinner available from Nazdar under the trade name P.O.P. Plus Thinner, No. 7730. According to the vendor, the thinner consists of 45% diacetone alcohol (4-hydroxy-4-methyl-2-pentanone), 45% 2-propoxyethanol (ethylene glycol monopropyl ether), and 10% 2-butoxyethanol acetate (ethylene glycol butyl ether acetate). The beads are transparent polyurethane, available from Microchem under the trade name Decosoft Transparent 18T. According to the vendor, the beads have the empirical formula R₁—NHCOO—R₂/R₃—NHCONH—R₄, having a composition of 99% polyurethane and 1% humidity and a median particle size of about 18 microns. Addition of the beads was also accomplished by several minutes of high speed, low shear mixing in a standard ink mixer. The solvent-base ink system of this example permits use of a smaller screen. The screen size is preferably in the range of about a 250 thread count down to about a 120 thread count screen. Screens smaller than 250 mesh can prohibit sufficient bead transmission, while screens larger than about 120 microns can cause a shadowing effect in the printed design, wherein the ink bleeds through and under the screen and onto the paper. Here again, slow solvent, specifically butyl carbitol, is added to a concentration of 5%. A 55 Shore A hardness blade was set at 16 degrees and the ink was printed upon a 59# uncoated cardstock. The printed article had a slightly rough, fine sandpaper like texture and substantially increased mar resistance.

The inks of the foregoing examples are compatible with most if not all secondary printing processes, including litho overprint, emboss foil, flat foil, flocking, flitter, virko, and bronzing. However, the use of some such processes in connection with the foregoing inks may necessitate certain process modifications. For example, paper can be advantageously coated to facilitate the printing of virko over the solvent-base mar-resistant ink. In foiling operations, it may be desirable to increase ink thixotropy to minimize the extent to which the foil silhouettes the beads protruding from the ink bed.

In other embodiments, different ink, beads, solvents, screens, and even printing processes can be used. For instance, the beads need not protrude from the ink bed. Properties of the ink, including texture, thixotropy, hardness, durability and feel, can be advantageously modified without using beads that stack or otherwise protrude above the ink bed. Particle shapes and sizes outside of the above-referenced preferred ranges and configurations can be implemented to achieve other textural, tactile, weather-resistance, mar resistance, toughness and other effects. As noted above, the beads need not be urethane or styrene. Rather, the beads or other microparticles can be any polymeric or inorganic material that imparts a desired property to the ink. Other colorants and binders can be selected, subject only to the possible need to adjust the amount and solubility of the beads in accordance with the teachings set forth above. Moreover, the examples set forth herein can be readily adapted to gravure inks, engraving inks, ink jet inks and inks for other printing processes. For example, by selecting appropriate solvents, inks, microparticle configuration, microparticle size, and microparticle construction in accordance with the foregoing teachings, one skilled in the art can readily create a gravure or engraving ink that imparts one or more of the advantages described above.

A number of embodiments of the present invention have been described. Nevertheless, it will be understood that various modifications may be made without departing from the spirit and scope of the invention. Accordingly, other embodiments are within the scope of the following claims.

What is claimed is:

1. A screen printing apparatus, comprising:
a blade set at an angle of about 5 to 25 degrees and having a durometer hardness of about 40-90 Shore A;
a screen having less than about 230 threads per inch; and
a screen printing ink that includes polymeric microparticles having a mean particle size of at least about 10-60 microns.

2. The apparatus of claim 1, wherein the microparticle material is selected from the group consisting of polyurethane, polystyrene, and polyolefin.

3. The apparatus of claim 1, wherein the microparticles are beads.

4. The apparatus of claim 3, wherein the beads are substantially spherical.

5. The apparatus of claim 1, wherein the microparticles have a substantially random geometry.

6. The apparatus of claim 1, wherein the microparticles are solid and have no substantial internal cavities.

7. The apparatus claims 1, wherein the microparticles have mean particle size of about 15 to 55 microns.

8. The apparatus of claim 3, wherein the microparticles have mean particle size of about 15 to 55 microns.

9. The apparatus of claim 1, further comprising a butyl carbitol slow solvent.

10. A screen printing ink comprising polymeric microparticles having a mean particle size of at least about 10 microns.

11. The ink of claim 10, wherein the microparticle material is selected from the group consisting of polyurethane, polystyrene, and polyolefin

12. The ink of claim 10, wherein the microparticles are beads.

13. The ink of claim 12, wherein the beads are substantially spherical.

14. The ink of claim 10, wherein the microparticles have a substantially random geometry.

15. The ink of claim 10, wherein the microparticles are solid and have no substantial internal cavities.

16. The ink of claims 10, wherein the microparticles have mean particle size of about 15 to 55 microns.

17. The ink of claim 11, wherein the microparticles have mean particle size of about 15 to 55 microns.

18. The ink of claim 10, further comprising a butyl carbitol slow solvent.

19. A method of using a screen printing ink, comprising:
applying to a screen a screen printing ink that includes polymeric microparticles having a mean particle size of at least about 10-60 microns; and
pressing the ink through the screen with a blade set at an angle of about 5 to 25 degrees and having a durometer hardness of about 40-90 Shore A;
wherein the screen has less than about 230 threads per inch; and

20. The method of claim 19, wherein the microparticle material is selected from the group consisting of polyurethane, polystyrene, and polyolefin.

21. The method of claim 19, wherein the microparticles are beads.

22. The method of claim 21, wherein the beads are substantially spherical.

23. The method of claim 19, wherein the microparticles have a substantially random geometry.

24. The method of claim 19, wherein the microparticles are solid and have no substantial internal cavities.

25. The method of claim 19, wherein the microparticles have mean particle size of about 15 to 55 microns.

26. The method of claim 21, wherein the microparticles have mean particle size of about 15 to 55 microns.

27. The method of claim 19, further comprising adding a butyl carbitol slow solvent to the ink.
